(19) United States
(12) Patent Application Publication
(10) Pub. No.: US 2026/0077941 A1
(43) Pub. Date: Mar. 19, 2026

(54) ACTUATOR FOR AN AEROSOL SPRAY DEVICE

(71) Applicant: The Salford Valve Company Limited, Escrick (GB)

(72) Inventors: Ghasem Ghavami NASR, York (GB); Peter SHAW, York (GB)

(21) Appl. No.: 18/988,005

(22) Filed: Dec. 19, 2024

(30) Foreign Application Priority Data
Sep. 18, 2024 (GB) 2413749.9

(51) Int. Cl. B65D 83/20

(52) U.S. Cl. CPC B65D 83/204

(57) ABSTRACT

An actuator for an aerosol spray device is disclosed. The actuator comprises a product passage for receiving product propelled by the aerosol spray device. The actuator further comprises a first channel, comprising a first channel inlet end connected to the product passage and a first channel outlet end for expelling the product. The first channel inlet end comprises an opening providing a fluid connection between the product passage and the first channel. The opening may have a cross sectional area of 0.5 to 3.0 mm².

### CROSS REFERENCE

This application claims priority to GB Application No. 2413749.9 filed Sep. 18, 2024, the entire disclosure of which is hereby incorporated herein by reference in its entirety.

### FIELD

This disclosure relates to an actuator. More particularly, an actuator for an aerosol spray device for expelling a product in the form of a spray. This disclosure also relates to an atomiser insert. More particularly, an atomiser for an aerosol spray device. The actuator and atomiser insert have particular application to aerosol spray devices which utilise a compressed gas propellant rather than a liquefied gas propellant.

### BACKGROUND

Broadly speaking, aerosol spray devices comprise a container holding a product to be discharged (or expelled) from the device by a gaseous propellant. The aerosol spray device is associated with a valving arrangement which is selectively operable to allow expulsion of the liquid product as a spray from an outlet orifice by means of the propellant provided within the container.

The product can be discharged from the aerosol spray device by a “compressed gas propellant” or “liquefied gas propellant”. The former incorporates a propellant which is a gas at 25° C. and at a pressure of at least 50 bar (e.g., air, nitrogen, or carbon dioxide). Such a gas does not liquefy in the aerosol spray device. On opening of the valving arrangement, the compressed gas “pushes” liquid in the spray device through the aforementioned outlet orifice that provides for atomisation. There are, in fact, two types of “compressed gas propellant” aerosols. In one type, only liquid from the container (“pushed-out” by the compressed gas) is supplied to the outlet orifice. In the other principal type, a portion of the propellant gas from the container is bled into the liquid being supplied to the outlet. As a result, the liquid atomises resulting in a two-phase, bubble-laden (also known as “effervescent”) flow to produce the spray. This latter format can produce finer sprays than the former.

In contrast, “liquefied gas propellant” aerosols use a propellant which is present (in the aerosol spray device) both in the gaseous and liquid phases and is miscible with the product being dispensed. The propellant may, for example, be butane, propane, or a mixture thereof. On discharge, the gas phase propellant “propels” the liquid in the container (including the dissolved, liquid phase propellant) through the outlet.

The outlet orifice through which product leaves the device may be provided in an atomiser insert assembled onto the actuator of the aerosol spray device, such that the product is discharged through the outlet orifice of the atomiser insert.

Atomiser inserts are used for both “liquified gas propellant” and “compressed gas propellant” spray devices. However, atomiser inserts for “liquified gas propellant” spray devices are typically incompatible with “compressed gas propellant” aerosol spray devices due to differences in their internal geometry. In particular, compared to aerosol spray devices which use “liquefied gas propellant”, “compressed gas propellant” spray devices typically require outlet orifices with smaller diameters (i.e., less than 0.14 mm) to achieve a fine spray. This is because the nature of “compressed gas propellant” (which has lower moisture content and energy) makes providing a uniform and homogenous spray challenging without an atomiser insert with a smaller orifice size. As such, atomiser inserts with smaller orifice diameters are specifically manufactured for “compressed gas propellant” aerosol spray devices. However, efficient manufacture of such atomiser inserts with small outlet orifices can be difficult. In particular, the heating and cooling experienced by a small injected moulded part can result in a higher rate of defects, leading to rejection of parts and wastage of both time and resources. Accordingly, the challenges associated with the manufacture of atomiser inserts with the required outlet orifice size poses a barrier to efficient manufacture of “compressed gas propellant” spray devices.

As such, it would be advantageous to provide an actuator and atomiser insert which can address one or more of the above-described problems.

### SUMMARY

The present disclosure addresses challenges associated with providing a uniform and homogenous spray profile for an aerosol spray device and providing an atomiser insert which improves spray performance.

According to a first aspect of the present disclosure, there is provided an actuator for an aerosol spray device. The actuator comprises a product passage for receiving product propelled by the aerosol spray device. The actuator further comprises a first channel, comprising a first channel inlet end connected to the product passage and a first channel outlet end for expelling the product. The first channel inlet end comprises, optionally terminates in, an opening providing a fluid connection between the product passage and the first channel. The present inventor has identified that by changing the internal dimensions of these and associated components within the actuator, the spray profile and spray properties produced by the aerosol spray can be improved. In particular, the spray uniformity, dryness, drop size, discharge rate, and throw distance can be improved as will be described in further detail below. Dryness refers to the time required for the product to dry up after it is discharged. Throw distance refers to the spray length, i.e., the distance to which the spray can be discharged. By optimising these and other spray properties, the spray is easier to apply, coats the target surface more evenly and disperses the product more effectively.

The opening providing a fluid connection between the product passage and the first channel may have a cross sectional area of 0.5 to 3.0 mm₂. A cross sectional area of 0.5-3.0 mm₂ for the opening enables the velocity of the product within the actuator to be controlled such that it exits the aerosol spray device at exit velocities of 0.2 to 35 m/s. Such exit velocities have been identified as leading to optimal spray properties (e.g. optimal spray uniformity, dryness, drop size, discharge rate, and throw distance).

In some implementations, the first channel has a length of 1.0-10.0 mm, preferably 2.0-7.0 mm. Providing a channel with a length in these ranges enables further control of the velocity of the product and enables product leakage to be reduced by decreasing the available volume for product to remain in the channel.

In some implementations, the first channel is cylindrical or cuboidal. A cylindrical channel enables reduced turbulent flow, decreases the surface area (thereby reducing friction of fluid flow), and results in improved structural strength by evenly distributing the internal pressure. Using a cuboidal channel reduces manufacturing cost (from the use of straight edges). Additionally, it enables improved space utilisation, in particular when there are multiple channels next to each other.

In some implementations, the opening is circular, oblong, or square. A circular opening provides similar advantages as mentioned previously for a cylindrical channel. An oblong or square opening can reduce manufacturing cost and improve space efficiency.

In some implementations, the cross sectional shape of the first channel and the shape of the opening are the same. Having the same shape between the channel and the opening enables the effervescent characteristic to be maintained for the product throughout the process of expelling the product, resulting in improved spray properties.

In some implementations, the first channel has the same cross sectional shape along a majority of its length, optionally along its entire length. A constant profile across most or the entire length of the channel enables reduced turbulent flow, again improving spray properties.

In some implementations, the longitudinal axis of the first channel is provided at 90-105° to the longitudinal axis of the product passage. Providing the first channel at an angle to the product passage in this range allows the spray direction to be adjusted at a relatively upstream position within the actuator, thereby resulting in improved uniformity of the resulting spray. This also enables leakage of the product to be reduced.

In some implementations, the product passage is tapered towards the opening, in other words its cross section gets smaller towards the opening. In some implementations, the product passage is tapered at an angle of 5-15° to the longitudinal axis of the product passage. A tapered profile enables improved control over the pressure drop as the product travels from the product passage to the first channel, improving spray properties.

In some implementations, the actuator comprises a chamber comprising: a chamber inlet end which is fluidly connected to the first channel outlet end; and a chamber outlet end for expelling the product. Providing such a chamber enables an improved effervescent flow to be provided, again improving spray properties.

In some implementations, the chamber has a smaller cross sectional area than the first channel. Having a chamber that is narrower than the channel enables control over the pressure drop, enabling improved control over spray properties.

In some implementations, the chamber has a greater cross sectional area than the first channel. Having a chamber with a larger cross section than the channel enables improved effervescent flow and maintaining of the effervescent characteristics of the product in the chamber from reduced pressure caused by the chamber's expansion in volume (compared to the channel). As noted above, this enables improved spray properties.

In some implementations, the chamber is a hollow cylinder with a thickness greater than or equal to the cross sectional area of the first channel. Using a hollow cylinder geometry for the chamber enables improved spray uniformity by distributing the product across a larger cross sectional area.

In some implementations, the actuator comprises a second channel, the second channel comprising: a second channel inlet end connected to the product passage; and a second channel outlet end fluidly connected to the chamber inlet end. The second channel inlet end comprises a second opening providing a fluid connection between the product passage and the second channel. Providing a second channel enables improved atomisation of the product, thereby providing improved spray uniformity.

In some implementations, the actuator comprises an atomiser insert fluidly connected to the first channel outlet end or, where present, the chamber outlet end. The provision of an atomiser insert, i.e., a component configured to assist in atomisation of the product as it is expelled from the aerosol spray device, can further help control and improve the spray properties of the discharge spray in particular by producing finer sprays.

In some implementations, the atomiser insert comprises one or more passageways around an outlet orifice of the atomiser insert for imparting a tangential velocity to the product during discharge. Using such passageways enables improved spray uniformity.

In some implementations, the diameter of the outlet orifice of the atomiser insert is between 0.14 to 3.00 mm, preferably between 0.14 to 1.50 mm, further preferably between 0.14 to 1.00 mm. These dimensions have been found to optimise spray properties whilst ensuring that the outlet orifice remains sufficiently large that it can be manufactured without undue difficulty.

In some implementations, the actuator comprises a boss for coupling a/the atomiser insert to the actuator. The atomiser insert may be coupled to a boss, enabling the atomiser insert to be manufactured separately, and allows for different atomiser inserts (e.g., for different use cases) to be fitted to the same actuator design.

In some implementations, the actuator is a button actuator, cap actuator, L-shaped actuator, or trigger pump actuator.

According to another aspect of the present disclosure, there is provided an aerosol spray device comprising a pressurised or pressurisable container configured to hold a product to be discharged from the device by a gaseous propellant, the aerosol spray device comprising an actuator according to any of the aspects, implementations or examples described herein.

In some implementations, the container contains the gaseous propellant, the gaseous propellant comprising a compressed gas, preferably compressed air. Use of compressed gas is more environmentally friendly than use of liquefied gas propellants such as butane.

In some implementations, the gaseous propellant is configured to be pressurised to a pressure between 50-2500 kPa, preferably between 500-2000 kPa.

In some implementations, the aerosol spray device is configured to expel the product using effervescent atomisation.

According to a further aspect, there is provided an atomiser insert for an aerosol spray device comprising a pressurised or pressurisable container configured to hold a product to be discharged from the device by a gaseous propellant. The atomiser insert comprises an outlet orifice and one or more passageways around the outlet orifice for imparting a tangential velocity to the product during discharge.

The depth of the one or more passageways of the atomiser insert may be between 0.05 to 0.60 mm. In some implementations, the width of the one of more passageways is between 0.20 to 0.60 mm. In some implementations, the length of the one or more passageways is between 0.40 to 2.00 mm. In some implementations, the diameter of the outlet orifice is between 0.14 to 1.50 mm. In some implementations, the length of the outlet orifice is between 0.30 to 0.80 mm. These dimensions have each been independently identified as improving the atomisation function of the atomiser insert. Two or more of the above dimensions may in some implementations be combined to provide a synergistic improvement in the atomisation provided.

In some implementations, the container contains the gaseous propellant, the gaseous propellant comprising a compressed gas, preferably nitrogen.

In some implementations, the gaseous propellant is configured to be pressurised to a pressure between 50 to 2500 kPa, preferably between 500 to 2000 kPa.

In some implementations, the atomiser insert is configured to expel the product using effervescent atomisation.

These and other aspects are merely illustrative of the innumerable aspects associated with the present disclosure and should not be deemed as limiting in any manner. These and other aspects, features, and advantages of the present disclosure will become apparent from the following detailed description when taken in conjunction with the referenced drawings.

### BRIEF DESCRIPTION OF THE DRAWINGS

In order to describe the manner in which the above-recited and other advantages and features of the disclosure can be obtained, a more particular description of the principles briefly described above will be provided by reference to specific embodiments thereof which are illustrated in the appended drawings. Understanding that these drawings depict only exemplary implementations of the disclosure and are therefore not to be considered to be limiting of its scope, the principles herein are described and explained with additional specificity and detail by way of example to illustrate aspects of the disclosure and with reference to the accompanying drawings, in which:

FIG. 1 shows an example actuator for an aerosol spray device, according to the present disclosure.

FIG. 2 shows a first cross section of the actuator of FIG. 1.

FIG. 3 shows a second cross section of the actuator of FIG. 1.

FIG. 4 shows the internal cavity of the actuator of FIG. 1.

FIG. 5 shows the internal cavity of a second example of an actuator, according to the present disclosure.

FIG. 6 shows the internal cavity of a third example of an actuator, according to the present disclosure.

FIG. 7 shows the internal cavity of a fourth example of an actuator, according to the present disclosure.

FIG. 8A shows the internal cavity of a fifth example of an actuator, according to the present disclosure.

FIG. 8B shows the internal cavity of a sixth example of an actuator, according to the present disclosure.

FIG. 9A shows a first example of a partial hemispheric product passage, according to the present disclosure.

FIG. 9B shows a second example of a partial hemispheric product passage, according to the present disclosure.

FIG. 10 shows a cross section of an example atomiser insert, according to the present disclosure.

FIG. 11 shows a frontal view of the atomiser insert of FIG. 10.

Throughout the description and the drawings, like reference numerals refer to like features.

### DETAILED DESCRIPTION

The following is a description of certain embodiments of the invention, given by way of example only and with reference to the drawings.

Various implementations of the disclosure are discussed in detail below. While specific implementations are discussed, it should be understood that this is done for illustration purposes only. A person skilled in the relevant art will recognize that other components and configurations may be used without parting from the spirit and scope of the disclosure. Thus, the following description and drawings are illustrative and are not to be construed as limiting. Numerous specific details are described to provide a thorough understanding of the disclosure. However, in certain instances, well-known or conventional details are not described in order to avoid obscuring the description. A reference to an implementation in the present disclosure can be a reference to the same implementation or any other implementation. Such references thus relate to at least one of the implementations herein.

The terms used in this specification generally have their ordinary meanings in the art, within the context of the disclosure, and in the specific context where each term is used. Alternative language and synonyms may be used for any one or more of the terms discussed herein, and no special significance should be placed upon whether or not a term is elaborated or discussed herein. In some cases, synonyms for certain terms are provided. A recital of one or more synonyms does not exclude the use of other synonyms. The use of examples anywhere in this specification including examples of any terms discussed herein is illustrative only and is not intended to further limit the scope and meaning of the disclosure or of any example term. Likewise, the disclosure is not limited to various implementations given in this specification. References to ranges of values or values “between” two values should be interpreted as encompassing the end points of those ranges unless otherwise specified.

The systems and methods of the present disclosure arise from a realisation by the inventor that the internal geometry of aerosol device actuators and their effect on aerosol spray properties have not previously been studied or experimented on in detail. While a significant amount of research has gone into the design of mixing chambers and channels further upstream in the device, the design of the actuator and flow path therein has received little attention. Surprisingly, the present inventor has identified that design of the actuator and atomiser insert, in particular in relation to the shape and dimension of various flow paths therein, has a profound impact on the flow properties of the spray that is generated. Further, by controlling the internal geometry of the actuator as discussed herein, atomiser inserts with larger orifice diameters of 0.14 mm or greater can be used to achieve a uniform and homogenous spray even for “compressed gas propellant” aerosol spray devices, thereby addressing drawbacks with existing systems that traditionally required smaller orifice diameters to achieve a fine spray. Specific aspects of the internal geometry of the actuator will now be discussed with reference to the figures.

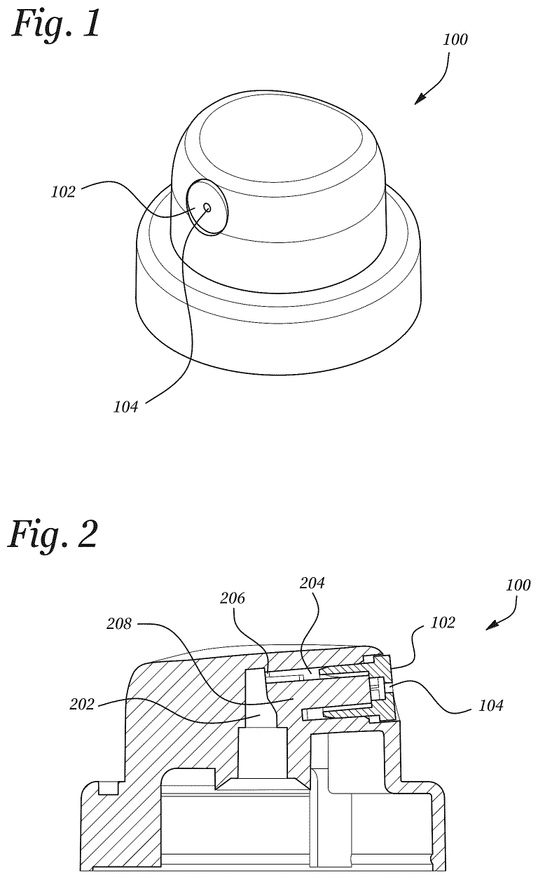

FIG. 1 shows an example of an actuator for an aerosol spray device, according to the present disclosure. The actuator 100 of FIG. 1 is a cap actuator, but the techniques described herein can apply to other actuator types, such as button, L-shaped, or trigger pump actuators. The specific choice of actuator type depends on its application and the product formulation with which it is to be used, however the principles and internal dimensions described herein apply to all types of actuator.

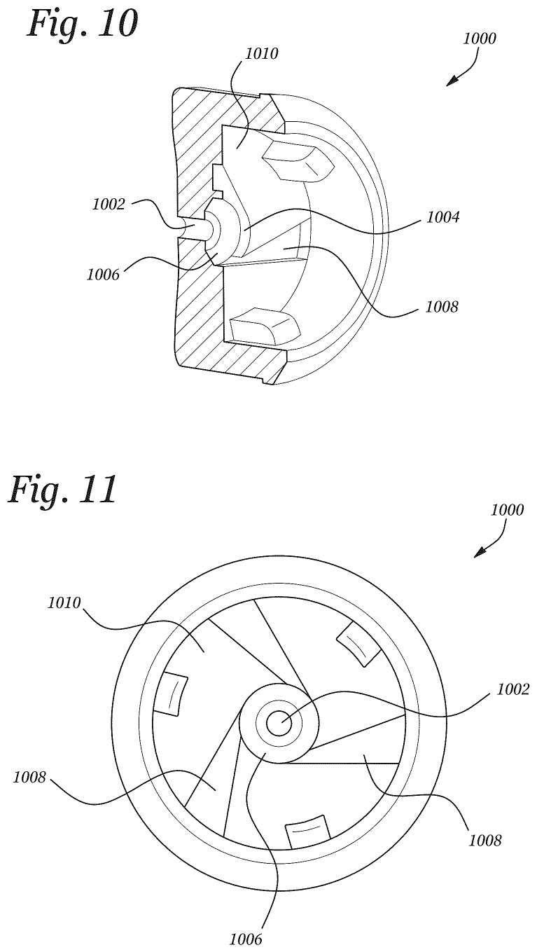

The actuator 100 is the component which activates the valve assembly of the aerosol spray device to enable discharge of the product, as is known in the art. The exact mechanism by which the actuator engages with the remaining valve mechanism(s) of the aerosol spray device are beyond the scope of this disclosure and will be known to a skilled reader. Suffice to say that, following operation (e.g. depression) of the actuator 100, product (typically mixed with or propelled by a propellant gas) will flow through the actuator 100 to be ejected from the device. The actuator 100 assists directing the product out of the spray device using its internal geometry. Also shown in FIG. 1 is an example atomiser insert 102. The atomiser insert has an outlet orifice 104 (also referred to as a nozzle). The internal geometry of the actuator, which is adjusted to control the spray performance, is outlined with reference to FIG. 2. Details of the actuator insert 102 are described in more detail in relation to FIGS. 10 and 11.

FIG. 2 shows a first cross section of the actuator 100 of FIG. 1. The actuator 100 comprises a product passage 202 for receiving product, propelled by a propellant, from the container of the aerosol spray device (not shown). The actuator 100 also comprises a channel 204 having an inlet end connected to the product passage 202 and an outlet end connected to the atomiser insert 102. The channel inlet end comprises, and optionally terminates in, an opening 206 which provides a fluid connection between the product passage 202 and the channel 204. Accordingly, product expelled from the container of the device can flow through product passage 202, through opening 206 into channel 204 and is then expelled from the outlet end of the channel 204. In this example, an atomiser insert is coupled to the actuator 100 and fluidly connects with the outlet end of channel 204. Accordingly, in this example product expelled from channel 204 passes through outlet 104 of atomiser insert 102 on its way to being expelled from the device.

The atomiser insert 102 may be coupled (optionally detachably) to the actuator 100 using a boss (also referred to as a post) 208. This enables the atomiser insert 102 to be manufactured separately, and enables different atomiser inserts (e.g., for different applications) to be fitted to the same actuator 100, making the actuator more versatile. As shown in FIG. 2, the boss 208 may form part of or extend from the wall of the product passage 202 within the actuator 100.

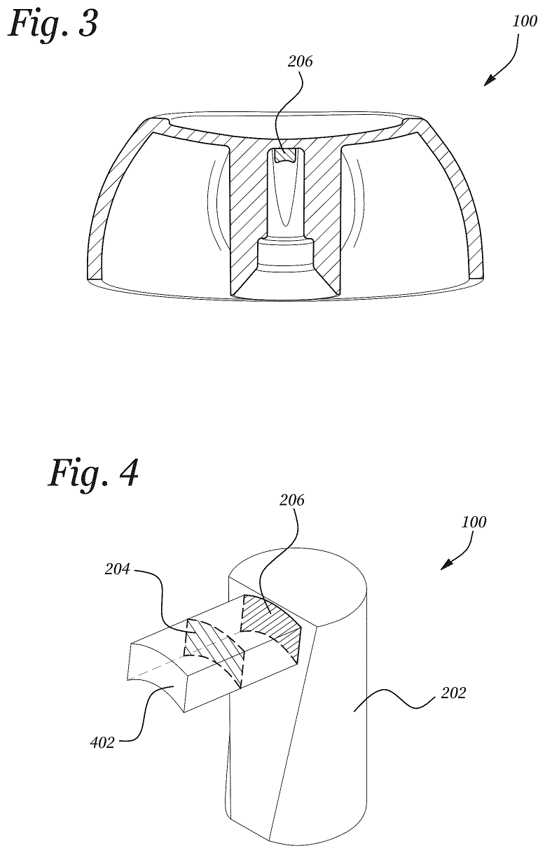

As noted above, the present inventor has identified that the geometry of the product passage 202, channel 204, opening 206, and atomiser insert 102 can significantly impact the properties of the spray produced by the aerosol spray device. Accordingly, the dimensions of these components will now be described in more detail in the following paragraphs with reference to FIGS. 3 to 11.

FIG. 3 shows a second cross section of the actuator 100 of FIG. 1, viewed from a perspective that is perpendicular to that of FIG. 2. The cross section of FIG. 3 highlights the geometry of the opening 206 of channel 204. In some implementations, the opening 206 has a cross sectional area of 0.5-3.0 mm₂. The cross sectional area of opening 206 has been shaded in FIG. 3 to aid understanding). An opening 206 with a cross sectional area in this range enables the velocity of the product to be controlled, such that a uniform and homogenous spray is provided, particularly when the actuator 100 is coupled to an atomiser insert 102. For example, for aerosol spray devices (typically pressurised to between 400-2500 kPa), the aforementioned cross sectional area of 0.5-3.0 mm₂ enables the velocity of the product to be at 0.5-10.0 m/s when entering the atomiser insert and at 0.2 m/s-35 m/s when exiting the atomiser insert as a fine spray (e.g., via an atomiser insert with a diameter between 0.14-3.00 mm).

The shape of the opening 206, as shown in FIG. 3, is oblong, but can be another shape, e.g., circular, diamond, or square. The corners and edges of the opening 206 can be rounded (also referred to as filleted) to reduce turbulent flow and improve structural strength by removing stress concentrations. In some implementations, the shape of the opening 206 can be adapted to match the shape of a boss 208. For example, in FIG. 3, the bottom edge of the opening 206 is curved to match the curvature of boss 208.

FIG. 4 shows the internal cavity of the actuator 100 of FIGS. 1-3. The internal cavity, as described herein, may also be considered to be the flow path within the actuator 100 which fluid passes through while being ejected from the device. In particular, the product passage 202, channel 204, opening 206, and outlet end 402 of the channel 204 is shown.

In some implementations, the channel 204 has a length of 1.0-10.0 mm, preferably 2.0-7.0 mm. A channel 204 with a length of 1.0-10 mm enables improved control over the velocity of the product and enables product leakage to be reduced by reducing the available length for product to remain in the channel. Specifically, limiting the channel 204 to a length of 1.0-10 mm enables the velocity of the product at the opening 206 to be maintained as it travels through the channel 204 towards the atomiser insert 104. In this way, the channel 204 synergistically works with the cross sectional area of the opening 206 to achieve a uniform and homogenous spray. The length of the channel 204 may be defined as the distance between the points of the channel 204 that are closest and farthest away from product passage 202. In some cases, the point of the channel that is closest to the product passage may be opening 206.

In some implementations, the product passage 202 is tapered towards the opening 206 of the channel 204, e.g., as shown in FIG. 4, which can help control the pressure drop from the product travelling from the product passage 202 to the channel 204. The product passage can take on a variety of shapes/profiles, not limited to those shown in the Figures.

In some implementations, the tapering of the product passage 202 can be used to angle the channel 204 with respect to the product passage. For example, as shown in FIG. 4, the channel 204 may be coupled to the product passage 202 perpendicular to its tapered face. The tapering therefore means that the channel 204 is effectively provided at an angle greater than 90° to the longitudinal axis of the product passage 202, where the longitudinal axis of product passage represents a line from the top of product passage straight down toward the point of product passage 202 where product enters from the container of the device. In some implementations, the channel 204 is coupled to product passage 202 such that the longitudinal axis of the channel 204 is provided at 90-105° to the longitudinal axis of the product passage 202.

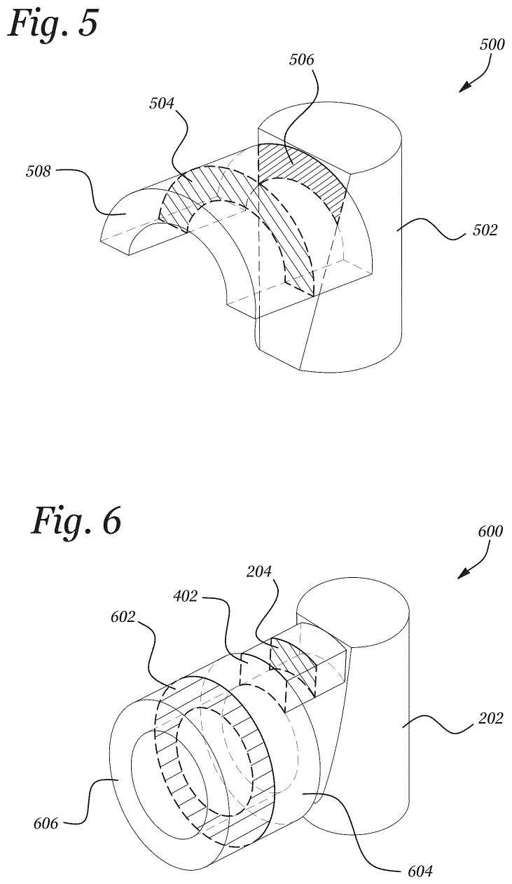

In some implementations, the channel 204 can be cylindrical or cuboidal. In some implementations, the channel 204 has the same cross sectional shape and/or area along its length as the opening 206, as shown in the example of FIG. 4 through shading of the respective cross sections of channel 204 and opening 206. However, in some implementations, the geometry of the channel 204 can differ from the shape of the opening 206, as shown in the example of FIG. 5.

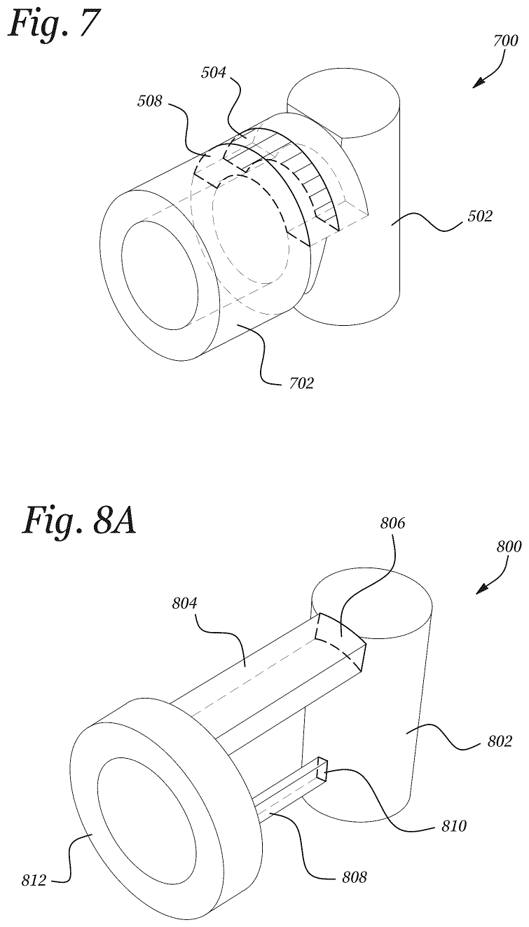

FIG. 5 shows the internal cavity (i.e., internal geometry or flow path) of a second example of an actuator 500, according to the present disclosure. Specifically, FIG. 5 shows an actuator 500 with an alternative design for the channel 504 and opening 506 compared to that of actuator 100 of FIGS. 1 to 4. The channel 504 has a geometry of a half hollow cylinder, and the opening 506 matches the shape of the channel 504. The cross sectional area of the channel 504 and the cross sectional area of the opening 506 have been shaded to aid understanding. As can be seen, the cross sectional area of channel 504 is larger than the cross sectional area of the opening 506. By providing a larger cross sectional area for the channel 504 compared to the opening 506, improved uniformity of the spray is enabled by distributing the product to a larger surface area at the outlet end 508 of channel 504. In some implementations, to further distribute the product across a larger surface area, the actuator comprises a further chamber provided downstream of the channel 504, as will be discussed below with reference to FIGS. 6 and 7.

FIG. 6 shows the internal cavity (i.e., internal geometry or flow path) of a third example of an actuator 600, according to the present disclosure. In this example, the actuator is similar to that of FIGS. 1-4 however now the actuator comprises a chamber 602 downstream of the channel 204. The chamber 602 comprises a chamber inlet end 604 fluidly connected to the channel outlet end 402 of channel 204. The chamber 602 also comprises a chamber outlet end 606 for expelling the product. In the example of FIG. 6, the chamber 602 has a hollow cylinder geometry.

When a chamber such as chamber 602 of FIG. 6 is fluidly connected to the channel 204, the total length of the channel 204 plus the chamber 602 may be limited to a length of 1.0-10.0 mm, preferably 2.0-7.0 mm (as described above), so as to reduce product leakage and maintain the velocity of the product. As in previous Figures, the cross sectional areas of channel 204 and chamber 602 are shaded to aid understanding. As can be seen, in this example the chamber 602 has a larger cross sectional area than the channel 204 and may therefore be considered an expansion chamber.

In some implementations, the chamber 602 may be a hollow cylinder. The height of the channel ring of chamber 602 (measured perpendicular to the flow of the product) may be equal to the height of channel 204, as depicted in FIG. 6. The inner radius of chamber 602 may be determined based on the radius/diameter of a boss (not shown), such that the boss may fit inside the inner radius of chamber 602 thereby providing a mechanism by which to attach actuator 600 to the boss. In some implementations, the actuator 600 comprises an atomiser insert (not shown) fluidly coupled to outlet end 606 of chamber 602. The dimensions of the chamber 602 (e.g., inner and/or outer radius of the hollow cylinder) may be further determined based on the dimensions of the atomiser insert, such that the atomiser insert can be fitted around or within chamber 602.

FIG. 7 shows the internal cavity (i.e., internal geometry or flow path) of a fourth example of an actuator 700, according to the present disclosure. FIG. 7 shows the actuator 500 of FIG. 5 in which a chamber 702 with a hollow cylinder geometry (like that of chamber 602 in FIG. 6) is fluidly attached to the channel outlet end 508 of the channel 504. Providing a channel 504 as shown in FIG. 7, which has a wider cross sectional area (see shaded area of channel 504) compared to channel 204 of FIG. 6, enables the product to be initially distributed across a larger surface area, thereby improving the distribution of the product in chamber 702. As described in relation to FIG. 6, the total length of the channel 504 plus the chamber 702 in FIG. 7 may be limited to a length of 1.0-10.0 mm, preferably 2.0-7.0 mm. Additionally, the dimensions of chamber 702 can be set to accommodate a post and atomiser insert, as described in FIG. 6.

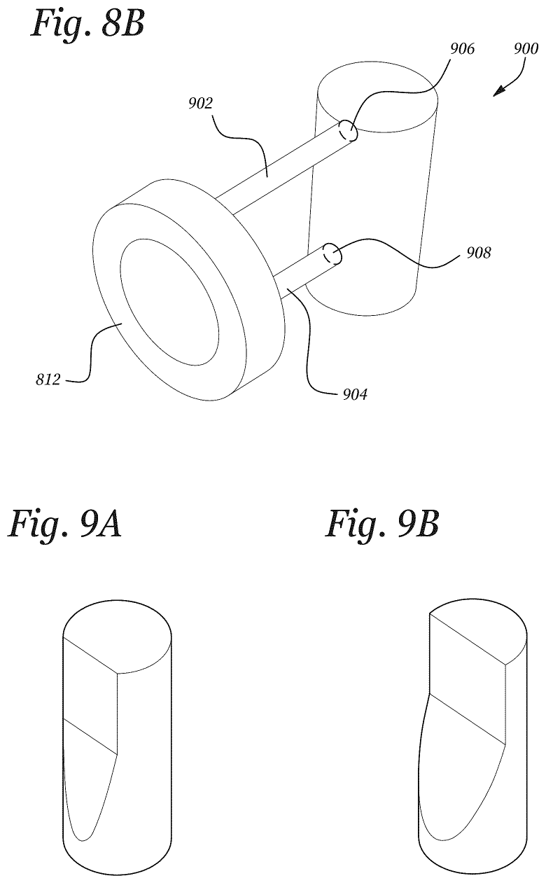

FIG. 8A shows the internal cavity (i.e., internal geometry or flow path) of a fifth example of an actuator 800, according to the present disclosure. FIG. 8A shows an actuator 800 that is similar to actuator 600 of FIG. 6, however in addition to first channel 804 there is also provided a second channel 808. First channel 804 has a similar construction to the channel 204 of actuator 600 of FIG. 6, although first channel 804 is longer. First channel 804 is fluidly connected to product passage 802 via first opening 806.

Like first channel 804, the second channel 808 comprises a second channel inlet end connected to the product passage 802 and a second channel outlet end at the opposite end. Like the first channel 804, the second channel 808 inlet end comprises, optionally terminates in, a second opening 810 which, analogously to the first opening 806 of the first channel 804, provides fluid connection between the product passage 802 and the second channel 808. The outlet ends of both first 804 and second 808 channels are in this example fluidly connected to the inlet end of a chamber 812, which has a similar construction to chamber 602 of FIG. 6.

Providing a second channel 808 improves spray uniformity compared to using only the first channel 804. In FIG. 8A, the shape and cross sectional areas of openings 806, 810 and channels 804, 808 differ from each other. FIG. 8B shows an alternative arrangement where the shape and cross sectional area of the first and second openings 906, 908 and channels 902, 904 are the same. Providing channels and/or openings with the same shape and/or cross sectional area can further improve spray uniformity.

The profile of the product passage described above can take on a variety of shapes not limited to those shown in the figures. Two examples of product passage profiles will now be discussed in more detail with reference to FIGS. 9A and 9B.

FIG. 9A shows a first example of a partial hemispheric product passage. The partial hemispheric product passage may be a combination of a cylindrical profile cut/tapered at an angle parallel to the longitudal axis of the product passage and an eccentric cone profile cut/tapered at an angle to the longitudinal axis of the product passage. Specifically, the top half of the product passage, which is where the channel is connected to, is the portion with the cylindrical profile, while the bottom half of the product passage is the portion with the eccentric cone profile. FIG. 9A shows a partial hemispheric product passage where the eccentric profile in the bottom half of the product passage is tapered at an angle of 5°. The partial hemispheric product passage provides an improved velocity profile to the product from the expansive to contractive shape of the product passage (from the bottom of the product passage which has a wider surface area to top of the product passage which has a narrower surface area). This results in an increase in pressure of the product in the product passage, leading to better control over the pressure drop.

FIG. 9B shows a second example of partial hemispheric product passage. The product passage of FIG. 9B is similar to that of 9A, however, the taper on the cylinder profile is increased and the taper on the eccentric profile is at a higher angle of 15°. This provides a further increase in the pressure on the product as it travels through the product passage, further improving the velocity profile of the product. FIG. 2 shows a cross section view of product passage 202 in actuator 100, which has a product passage profile corresponding to the partial hemispheric profile shown in FIG. 9B.

The above discussion has focused primarily on the design and dimensions of the actuator 100. The present inventor has identified that it can also be beneficial to devise atomiser inserts, which can be provided as part of or attached to the actuator 100, having specific dimensions, shapes and designs so as to further assist in controlling spray properties. With this in mind, FIG. 10 shows a cross section of an example atomiser insert 1000, according to the present disclosure. In some implementations, the atomiser insert 1000 (also known as just an “insert”) may be connected to a channel outlet end or chamber outlet end of an actuator such as actuator 100 or any of the actuators discussed above. In this case, the atomiser insert 1000 is typically the final component which the product passes through before being discharged from the aerosol spray device. The atomiser insert 1000 can assist in the production of a fine spray by providing an internal structure/flow path which facilitates the mechanical break up of the product prior to expulsion.

FIG. 10 shows an atomizer insert 1000 having an outlet orifice 1002, a first swirl chamber 1004, a second swirl chamber 1006, and a passageway 1008 (also referred to as a “swirl arm” or “swirl channel”). In some implementations, the diameter of the outlet orifice 1002 of the atomiser insert 1000 is between 0.14-3.00 mm, preferably between 0.14-1.50 mm or 0.14-1.00 mm. By controlling the internal geometry of the actuator as discussed herein, atomiser inserts with larger orifice diameters of 0.14 mm or greater can be used in “compressed gas propellant” aerosol spray devices to achieve a uniform and homogenous spray. This addresses a shortcoming of existing systems which require atomiser inserts with smaller outlet orifices that are difficult to manufacture.

In some implementations, the length of the outlet orifice 1002 is between 0.30-0.80 mm. Limiting the length of the outlet orifice to the aforementioned range enables a uniform spray to be provided. The length of the outlet orifice can be divided by the diameter of the outlet orifice to determine a “Land Length Ratio” (also known as a “L/D ratio”). At a high L/D ratio, the throw distance and angle of the cone produced by the spray (also known as a “spray angle”) is decreased. Whereas, at a low L/D ratio, the throw distance and angle of the cone produced by the spray is increased. The aforementioned ranges for the outlet orifice diameter and outlet orifice length enable an optimal L/D ratio, and therefore an optimal throw and spray angle to be provided, thereby improving spray properties.

The internal face 1010 of the atomiser insert 1000 may abut against the face of a boss (e.g. boss 208 of FIG. 2, not shown) such that said faces of the boss and the atomiser insert 1000 enclose the first swirl chamber 1004, second swirl chamber 1006, and the passageway 1008. In some implementations, the atomiser insert 1000 comprises one or more passageways 1008 (also known as “swirl arms”) around and extending outwardly from the outlet orifice 1002 of the atomiser insert 1000 for imparting a tangential velocity to the product during discharge. This tangential velocity provided by the passageways 1008 promotes droplet breakup, thereby improving spray uniformity. In some implementations, instead of providing the passageway 1008 in the atomiser insert 1000, it is provided on the surface of the boss. The one or more passageways 1008 will be discussed in further detail with reference to FIG. 11.

FIG. 11 shows a frontal view of the atomiser insert 1000 of FIG. 10, according to the present disclosure. The frontal view in this case is the side of the insert that faces the actuator and which the product flows into when the atomiser insert is connected to the actuator. In other words, when viewing the atomizer as in FIG. 11, the direction of fluid flow in use is into the page. In FIG. 11, three passageways 1008 of the atomiser insert 1000 are shown, which are arranged in a spiral geometry/configuration. In some implementations, the passageways 1008 can be arranged in a square geometry/configuration. A square geometry is particularly advantageous for viscous products (e.g., up to 50 Centipoise (Cp)), as it enables the viscous product to travel with changing characteristics within the passageway 1008.

In some implementations, a different number of passageways 1008 (e.g., 2 to 8, or more) and/or passageway configurations/geometries (e.g., square, star, or spiral) may be used compared to that shown in FIG. 11. In some implementations, specific dimensions of the one or more passageways 1008 may be defined. That is, the (maximum) width of the one or more passageways 1008 may be between 0.20-0.60 mm. The (maximum) length may be between 0.40-2.00 mm. The (maximum) depth of the one or more passageways may be between 0.05-0.60 mm. Dimensions in this range ensure that an optimum amount of product is imparted with a tangential velocity, thereby increasing sheet breakup and improving spray uniformity. Specifically, the product which is fed into the outer parts of the passageways 1008 before entering the first swirl chamber 1004 and second swirl chamber 1006 generates a vortex flow from the tangential velocity imparted to the product. This leads to the generation of a conical liquid sheet at the outlet orifice 1002, which subsequently disperses into a fine spray. Accordingly, controlling the dimensions of the passageways 1008 improves breakup of the product, thereby improving spray properties. In particular, increasing the depth improves spray performance for more viscous products (e.g., dry shampoo) because it makes it easier for the product to move in the passageway, enabling a more consistent breakup and effervescent flow of the product to take place.

The aerosol spray device described herein may comprise a pressurised or pressurisable container which holds a product to be discharged from the device by a gaseous propellant. The gaseous propellant is preferably a gas at a temperature of 25° C. and a pressure of at least 50 bar. In some implementations, the gaseous propellant is configured to be pressurised to a pressure between 50-2500 kPa, preferably between 500-2000 kPa. The gaseous propellant may be a compressed gas, such as compressed air, nitrogen, or carbon dioxide. In some implementations, the gaseous propellant may be butane, propane, or a mixture thereof. In some implementations, the aerosol spray device is configured to expel the product using effervescent atomisation.

The product may be a material or compound selected from the group consisting of pharmaceutical, agrochemical, fragrance, air freshener, odour neutraliser, sanitizing agent, polish, insecticide, depilatory chemical (such as calcium thioglycolate), epilatory chemical, cosmetic agent, deodorant, anti-perspirant, anti-bacterial agents, anti-allergenic compounds, and mixtures of two or more thereof.

It is to be understood that the above description is intended to be illustrative, and not restrictive. Many other implementations will be apparent to those of skill in the art upon reading and understanding the above description. Although the present disclosure has been described with reference to specific example implementations, it will be recognized that the disclosure is not limited to the implementations described but can be practiced with modification and alteration within the spirit and scope of the appended claims. Accordingly, the specification and drawings are to be regarded in an illustrative sense rather than a restrictive sense. The scope of the disclosure should, therefore, be determined with reference to the appended claims, along with the full scope of equivalents to which such claims are entitled.

While at least one exemplary embodiment has been presented in the foregoing detailed description, it should be appreciated that a vast number of variations exist, only some of which have been mentioned above. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof.

Also disclosed are the following clauses:

An actuator for an aerosol spray device, wherein the actuator comprises a product passage for receiving product propelled by the aerosol spray device; and a first channel, comprising a first channel inlet end connected to the product passage, wherein the first channel inlet end comprises an opening providing a fluid connection between the product passage and the first channel, the opening having a cross sectional area of 0.5-3.0 mm₂; and a first channel outlet end for expelling the product.

An actuator of clause 1, wherein the first channel has a length of 1.0-10.0 mm, preferably 2.0-7.0 mm.

An actuator wherein the first channel is cylindrical or cuboidal.

An actuator wherein the opening is circular, oblong, or square.

An actuator wherein the cross sectional shape of the first channel and the shape of the opening are the same.

An actuator wherein the first channel has the same cross sectional shape across its length.

An actuator wherein the longitudinal axis of the first channel is provided at 90-105° to the longitudinal axis of the product passage.

An actuator wherein the product passage is tapered towards the opening.

An actuator wherein the product passage is tapered at an angle of 5-15° to the longitudinal axis of the product passage.

An actuator wherein the product passage has a partial hemispheric profile.

An actuator wherein the actuator comprises an atomiser insert fluidly connected to the first channel outlet end.

An actuator wherein the actuator comprises a chamber comprising a chamber inlet end fluidly connected to the first channel outlet end; an a chamber outlet end for expelling the product.

An actuator wherein the chamber has a smaller cross sectional area than the first channel.

An actuator wherein the chamber has a greater cross sectional area than the first channel.

An actuator wherein the chamber is a hollow cylinder with a thickness greater than or equal to the cross sectional area of the first channel.

An actuator wherein the actuator comprises a second channel, the second channel comprising a second channel inlet end connected to the product passage, wherein the second channel inlet end comprises a second opening providing a fluid connection between the product passage and the second channel; and a second channel outlet end fluidly connected to the chamber inlet end.

An actuator wherein the actuator comprises an atomiser insert fluidly connected to the chamber outlet end.

An actuator wherein the atomiser insert comprises one or more passageways around an outlet orifice of the atomiser insert for imparting a tangential velocity to the product during discharge.

An actuator wherein the diameter of a/the outlet orifice of the atomiser insert is between 0.14-3.00 mm, preferably between 0.14-1.00 mm.

An actuator wherein the actuator comprises a boss for coupling a/the atomiser insert to the actuator.

An actuator wherein the actuator is a button actuator, cap actuator, L-shaped actuator, or trigger pump actuator.

An aerosol spray device comprising a pressurised or pressurisable container configured to hold a product to be discharged from the device by a gaseous propellant, the aerosol spray device comprising an actuator as described herein.

An aerosol spray device wherein the container contains the gaseous propellant, the gaseous propellant comprising a compressed gas, preferably compressed air.

An aerosol spray device wherein the gaseous propellant is configured to be pressurised to a pressure between 50-2500 kPa, preferably between 500-2000 kPa or 50-200 kPa.

An aerosol spray device wherein the aerosol spray device is configured to expel the product using effervescent atomisation.

An atomiser insert for an aerosol spray device comprising a pressurised or pressurisable container configured to hold a product to be discharged from the device by a gaseous propellant, the atomiser insert comprising an outlet orifice; and one or more passageways around the outlet orifice of the atomiser insert for imparting a tangential velocity to the product during discharge, wherein the depth of the one or more passageways is between 0.05-0.60 mm.

An atomiser insert wherein the width of the one of more passageways is between 0.20-0.60 mm.

An atomiser insert wherein the length of the one or more passageways is between 0.40-2.00 mm.

An atomiser insert wherein the diameter of the outlet orifice is between 0.14-1.50 mm.

An atomiser insert wherein the length of the outlet orifice is between 0.30-0.80 mm.

An atomiser insert wherein the container contains the gaseous propellant, the gaseous propellant comprising a compressed gas, preferably nitrogen.

An atomiser insert wherein the gaseous propellant is configured to be pressurised to a pressure between 50-2500 kPa, preferably between 500-2000 kPa or 50-200 kPa.

An atomiser insert wherein the atomiser insert is configured to expel the product using effervescent atomisation.

The preferred embodiments of the disclosure have been described above to explain the principles of the present disclosure and its practical application to thereby enable others skilled in the art to utilize the present disclosure. However, as various modifications could be made in the constructions and methods herein described and illustrated without departing from the scope of the present disclosure, it is intended that all matter contained in the foregoing description or shown in the accompanying drawings, including all materials expressly incorporated by reference herein, shall be interpreted as illustrative rather than limiting. Thus, the breadth and scope of the present disclosure should not be limited by the above-described exemplary embodiment but should be defined only in accordance with the following claims appended hereto and their equivalents.

1. An actuator for an aerosol spray device, wherein the actuator comprises:
a product passage for receiving product propelled by the aerosol spray device; and
a first channel, comprising:
a first channel inlet end connected to the product passage,
wherein the first channel inlet end comprises an opening providing a fluid connection between the product passage and the first channel, the opening having a cross sectional area of 0.5-3.0 mm₂; and
a first channel outlet end for expelling the product.

2. The actuator of claim 1, wherein the first channel has a length of 1.0-10.0 mm, preferably 2.0-7.0 mm.

3. The actuator of claim 1, wherein the actuator comprises an atomiser insert fluidly connected to the first channel outlet end.

4. The actuator of claim 1, wherein the actuator comprises a chamber comprising:
a chamber inlet end fluidly connected to the first channel outlet end; and
a chamber outlet end for expelling the product.

5. The actuator of claim 4, wherein the chamber has a greater cross sectional area than the first channel.

6. The actuator of claim 4, wherein the chamber is a hollow cylinder.

7. The actuator of claim 4, wherein the actuator comprises a second channel, the second channel comprising:
a second channel inlet end connected to the product passage, wherein the second channel inlet end comprises a second opening providing a fluid connection between the product passage and the second channel; and
a second channel outlet end fluidly connected to the chamber inlet end.

8. The actuator of claim 4, wherein the actuator comprises an atomiser insert fluidly connected to the chamber outlet end.

9. The actuator of claim 3, wherein the atomiser insert comprises one or more passageways around an outlet orifice of the atomiser insert for imparting a tangential velocity to the product during discharge.

10. The actuator of claim 3, wherein the diameter of a/the outlet orifice of the atomiser insert is between 0.14-3.00 mm, preferably between 0.14-1.00 mm.

11. An aerosol spray device comprising a pressurised or pressurisable container configured to hold a product to be discharged from the device by a gaseous propellant, the aerosol spray device comprising an actuator according to claim 1.

12. An atomiser insert for an aerosol spray device comprising a pressurised or pressurisable container configured to hold a product to be discharged from the device by a gaseous propellant, the atomiser insert comprising:
an outlet orifice; and
one or more passageways around the outlet orifice of the atomiser insert for imparting a tangential velocity to the product during discharge, wherein the depth of the one or more passageways is between 0.05-0.60 mm.

13. The atomiser insert of claim 12, wherein the width of the one of more passageways is between 0.20-0.60 mm.

14. The atomiser insert of claim 12, wherein the length of the one or more passageways is between 0.40-2.00 mm.

15. The atomiser insert of claim 12, wherein the diameter of the outlet orifice is between 0.14-1.50 mm.

16. The atomiser insert of claim 12, wherein the length of the outlet orifice is between 0.30-0.80 mm.

17. The atomiser insert of claim 12, wherein the gaseous propellant is configured to be pressurised to a pressure between 50-2500 kPa, preferably between 500-2000 kPa or 50-200 kPa.

18. The atomiser insert of claim 12, wherein the atomiser insert is configured to expel the product using effervescent atomisation.

19. The aerosol spray device of claim 12, wherein the gaseous propellant is configured to be pressurised to a pressure between 50-2500 kPa, preferably between 500-2000 kPa.

20. The aerosol spray device of claim 12, wherein the aerosol spray device is configured to expel the product using effervescent atomisation.
